(19) United States
(12) Patent Application Publication
(10) Pub. No.: US 2019/0325373 A1
(43) Pub. Date: Oct. 24, 2019

(54) SYSTEM AND METHOD FOR MONITORING USAGE OF AN INFORMATION KIOSK

(71) Applicant: DBSI, Inc., Chandler, AZ (US)

(72) Inventors: John Dillon, Gilbert, AZ (US); Debra Dillon, Gilbert, AZ (US); Jim Ransco, Paradise Valley, AZ (US); Jianing Chen, Gilbert, AZ (US); Nathan Moore, Scottsdale, AZ (US)

(73) Assignee: DBSI, Inc., Chandler, AZ (US)

(21) Appl. No.: 15/956,721

(22) Filed: Apr. 18, 2018

(51) Int. Cl. G06Q 10/06; G06Q 40/02; G06F 3/041; G06F 3/0482

(52) U.S. Cl. CPC G06Q 10/063112; G06F 3/0482; G06F 3/041; G06Q 40/02

(57) ABSTRACT

The present disclosure relates to a system that includes at least one information kiosk, a server connected to the at least one information kiosk, a local network, and a plurality of browser-enabled computing devices connected to the server via the local network; wherein, the server is configured to alert one or more of the browser-enabled computing devices regarding a user of the information kiosk. The information kiosk is navigable, preferably by touch using a touch screen. In an embodiment, the touch screen includes at least one help widget that a user can select so as to be provided with assistance in real time. Browser-enabled computing device users have the opportunity to review assistance requests in the customer alert queue, and either accept or reject the assistance requests. In another embodiment, the system can generate strategic alerts without an express request for assistance from the user of the information kiosk.

### BACKGROUND OF THE INVENTION

### 1. Field of the Invention

The present invention relates to a system and method for monitoring usage of an information kiosk.

### 2. Description of the Related Art

An information kiosk is a tool that provides information regarding products and/or services to a user, typically situated within a place where such products and/or services are offered. The information kiosk will include an interactive touch screen that presents information to a user. For example, in a banking branch, one or more information kiosk may take the place of a brochure rack, and instead of paper brochures, the customer can navigate the touch screen for financial services information ranging from types of available bank accounts, credit cards, investment products, loans, and insurance. Additionally, in some cases, users may employ swiping motions, gestures, and/or voice commands to operate the information kiosk.

The information kiosk will typically be operated by a computer system integral to the kiosk that is programmed to present the information in a touch-centric manner. Information kiosks can be networked or standalone. Information can be arranged in a menu format where each topic is separately shown. The screen is navigable by the user, and once the user obtains the basic information, the user may decide to ask questions to personnel. However, the customer may have to wait for an available employee, or set an appointment. Many customers will not follow through and may even go to a competing company. Thus, a potential customer may be lost. Additionally, there is no way to even know the number of customers looking at various different products and/or services to gauge customer interest.

### SUMMARY OF THE INVENTION

One aspect of the disclosure relates to a system that includes at least one information kiosk, a server connected to the at least one information kiosk, a local network, and a plurality of browser-enabled computing devices connected to the server via the local network; wherein, the server is configured to alert one or more of the browser-enabled computing devices regarding a user of the information kiosk. The information kiosk is navigable, preferably by touch using a touch screen, and the information kiosk provides products and/or services information during the navigation.

In an embodiment, the touch screen includes at least one help widget, such as a “help button,” that a user can select so as to be provided with assistance in real time. When the user selects the help widget, the information kiosk sends an assistance request to the server, which in turn places the assistance request into a customer alert queue. The assistance request can includes a kiosk identifier and topic information that is gleaned from the current navigation point and/or navigation history, and a subset of browser-enabled computing devices are selected based at least in part on the topic information and employee subject matter expertise.

In an embodiment, the customer alert queue is organized such that the browser-enabled computing devices select only those assistance requests that match according to subject matter expertise of the browser-enabled computing device user. For example, a browser-enabled computing device logged in by a loan officer might receive assistance requests with customer interest information only pertaining to mortgages or car loans. In some embodiments, the selection criteria would set forth logic such that available employees having matched subject matter expertise would be selected before other available employees. In this case, the user would still be provided assistance (and possibly referred for follow-up assistance, if need be) even if a subject matter expert was not presently available. In an embodiment, each assistance request in the customer alert queue is time-stamped, and the assistance requests in the queue are arranged in chronological order, so that user requests can be acted upon in order. In other cases, the customer alert queue could be organized as a priority queue where certain topics or customers are given priority.

In an embodiment, browser-enabled computing device users have the opportunity to review assistance requests in the customer alert queue, and either accept or reject the assistance requests. If the browser-enabled computing device user accepts the assistance request, the request is removed from the customer alert queue and there would be an expectation that assistance would be rendered. Additionally, the browser-enabled computing device can preferably be configured to capture information regarding interactions with the customer and the disposition of the matter, including whether a “sale” was made. Collection of such information could further be used in a variety of ways, such as being used to generate various reports or input into an analytics system.

In another embodiment, the system can generate strategic alerts without an express request for assistance from the user of the information kiosk. It is to be understood that this embodiment is substantially similar to the embodiments described above except that a strategic alert is generated when a user lands on particular navigation point(s) without the user explicitly requesting assistance. As an example, in a banking application, when a user lands on a section of content that is labeled “Opening New Bank Account,” the server can generate a strategic alert for “New Accounts” which can be placed in the customer alert queue. In this case, a new accounts specialist, for example, might accept the alert. The new accounts specialist, armed with information as to the user's interest in opening a low-cost new account, would be expected to contact the user in person and might ask whether the user was aware, for example, that the bank was waiving account opening fees for new checking accounts this month. Such strategic alerts are a useful tool to understand what a particular client (or prospect) is looking for and would help spur a face-to-face engagement to discuss the branch's offerings.

### BRIEF DESCRIPTION OF THE DRAWINGS

FIG. 1 illustrates a system for monitoring usage of an information kiosk, according to an embodiment.

FIG. 2 illustrates a main menu of an exemplary information kiosk, according to another embodiment.

FIG. 3 illustrates an exemplary information kiosk including a help widget, according an embodiment.

FIG. 4 and FIG. 5 illustrate exemplary management reports tracking usage of an information kiosk, according to an embodiment.

FIG. 6 illustrates a system for monitoring usage of an information kiosk, according to another embodiment.

### DETAILED DESCRIPTION OF THE INVENTION

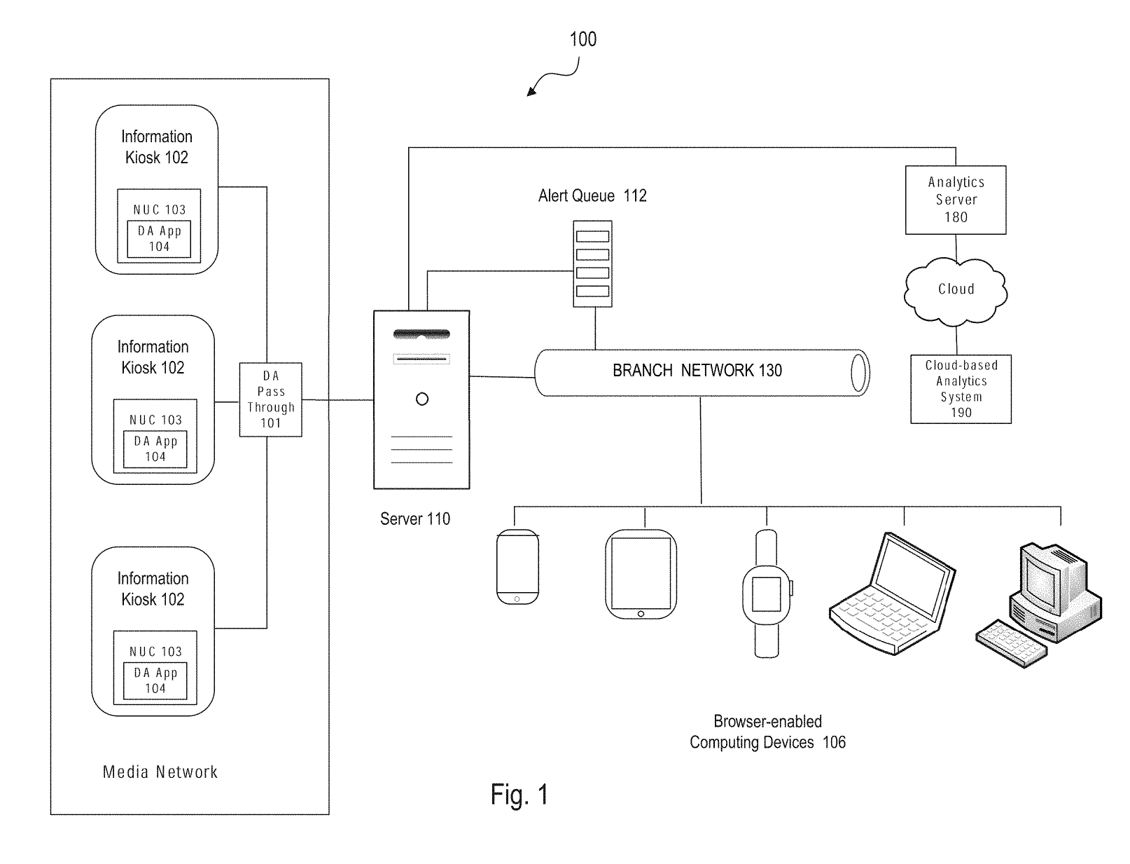

Referring to FIG. 1, an exemplary system for monitoring an information kiosk 100 is illustrated, according to an embodiment. As shown, the system 100 includes a plurality of information kiosks 102 that are operatively connected to a server 110. The server 110 is operatively connected to a branch network 130. A plurality of browser-enabled computing devices 106 is operatively connected to the server 110 via the branch network 130. The browser-enabled computing devices 106 include any device that includes a browser (i.e., a program with a graphical user interface for displaying mark-up language files, such as HTML files). Such browser-enabled computing devices include, but are not limited to, tablet computers, smartphones, laptops, desktop computers, workstations, various wearable devices such as smart watches, etc., which have installed a suitable browser. Alternatively, however, the devices 106 may include appropriate software to allow the same or substantially similar functionality using a suitable application program instead of a browser. The information kiosks 102 are navigable, preferably by touch using a touch screen, and each information kiosk 102 provides products and/or services information during the navigation. Additionally, the information kiosks 102 can provide other functionality (e.g., allow the user to check account balance) but a kiosk that only provides information will suffice. Additionally, in some cases, users may employ other means to navigate the information kiosks 102, such as by swiping motions, gestures, and voice commands. As will be described in greater detail, the server 110 is configured to monitor usage of the information kiosks 102, and alert the browser-enabled computing devices 106 in certain situations. Although three information kiosks 102 are depicted, it is to be understood that fewer or greater than the number of information kiosks 102 shown may be used including even a single information kiosk 102. Furthermore, it is to be understood that the information kiosks 102 can be located in the same building, and in many cases are located on the same floor as the browser-enabled computing devices 106. Additionally, it is to be understood that although an alert queue 112 is shown as a separate component, the alert queue 112 would preferably be implemented as a data structure (in the memory of) the server 110 or existing elsewhere but accessible by the server 110. Additionally, an analytics server 180 is shown operatively connected to the server 110. Further, a cloud-based analytics system 190 is linked via the Internet (“Cloud”) to the analytics server 180. Although the analytics server 180 and the cloud-based analytics system 190 are depicted, it is to be understood that these elements are optional. That is, in some cases, neither element will be present in the system 100. In other cases, only the cloud-based analytics system 190 will be present. In embodiments, the analytics server 180 comprises the S4 server available from Cash Flow Management, Inc. of Chandler, Ariz. In embodiments, the cloud-based analytics system 190 comprises iQ software, available from Cash Flow Management, Inc. It is to be appreciated that the system 100 illustrated in FIG. 1 is provided for illustrative purposes, and that actual implementations (banking or non-banking) may vary from the diagram.

In an embodiment, each of the information kiosks 102 includes a computing device, such as the illustrated NUC (“next unit of computing”) device 103, which controls the respective kiosk 102. In other embodiments, however, the functionality of the NUC 103 can be included within the kiosks 102 themselves. The NUC 103 includes a processor and memory. The memory can include ROM/RAM, flash memory and the like. An application 104 labeled herein as DA (“digital alerts”) app 104 is stored in the memory, and includes program code non-transitorily embedded thereon. This program code includes various programs executable by the processor to present information in an interactive manner using the kiosk 102, and to interact with the server 110, such as to provide information as to the navigation paths of users interacting with the information kiosk 102, and as will be discussed, assistance requests. Additionally, the NUC 103 can have access to the Internet, linked to a Wi-Fi network or the like. Each of the information kiosks 102 are operatively linked to a DA Pass Through 101 that creates a restricted gateway for all communication from the DA App 104, which secures the connection to the server 110 via a suitable network. The information kiosks 102 include a touchscreen and various input/output devices such as a built-in speaker and microphone. The touchscreen can include any suitable resistive or capacitive touch screen, or any other type of suitable touch-sensitive screen using known or later developed technology.

In the following description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various applications that can be written in HTML, PHP, Javascript, jQuery, etc.

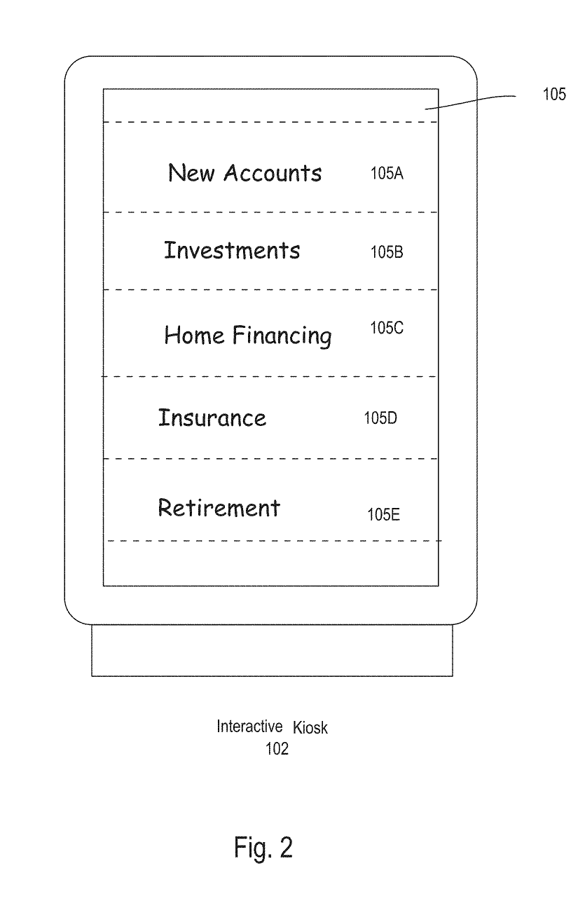

Referring to FIG. 2, an exemplary main menu of an information kiosk 102 is illustrated. As shown the information kiosk 102 includes a touch screen 105 that displays information according to topic. In the illustrated touch screen 105, the topics displayed include new accounts 105A, investments 105B, home financing 105C, insurance 105D, and retirement 105E. It is to be understood that these topics are presented herein for illustrative purposes only. Furthermore, although information is presented in a menu format, it is to be understood that other ways of presenting information may suffice. In operation, a user interacting with the information kiosk 102 would select a topic from the touch screen 105, such as new accounts 105A, and then proceed with obtaining additional information regarding the topic by navigating through the selected topic. For example, once the user selected “New Accounts” (e.g., touched new accounts 105A) the user might be presented with a choice of either “Checking Account” or “Savings Account.” If the user selected “Checking Account,” the user would then be presented with information related to the bank's checking account offerings. Likewise, if the user selected “Savings Account,” information relating to the bank's savings offerings would be presented. It is to be understood that such presentation of information could include text, audio, and/or video presentations, using techniques known in the art. In an embodiment, as the user navigates through a topic, at one or more predetermined navigation point, the information kiosk 102 generates a strategic alert to the server 110. Such strategic alerts are a useful tool to understand what a particular client (or prospect) is looking for and would help spur a face-to-face engagement to discuss the branch's offerings. In operation, once the information kiosk 102 determines a certain navigation point is reached, a kiosk identifier and topic identifier are sent to the server 110 (via the DA Pass Through 101). The server 110 thereupon bundles this information along with a time stamp, and places a strategic alert request into the alert queue 112. The alert queue 112 can be organized as a FIFO queue or a priority queue, for example.

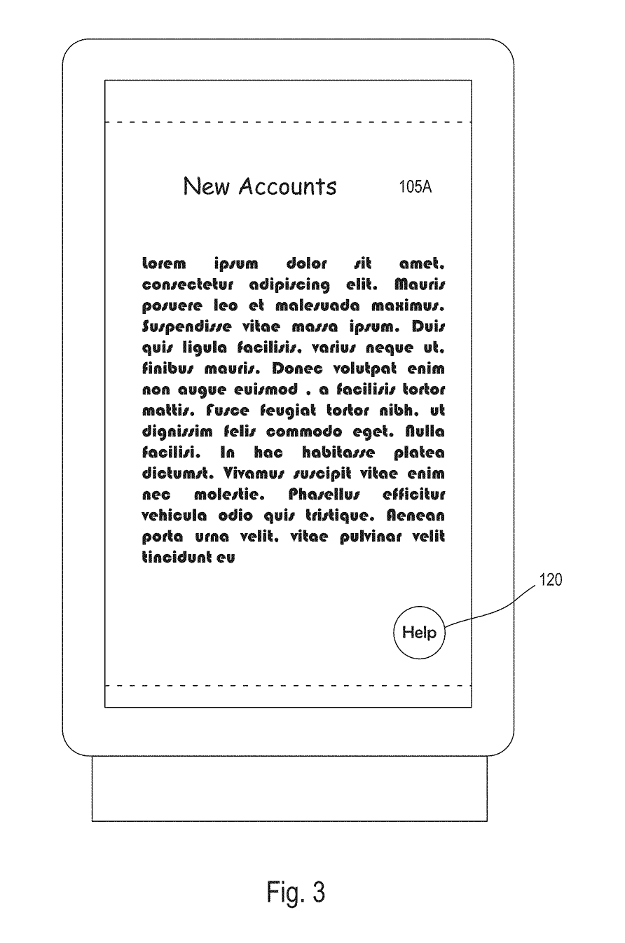

Referring to FIG. 3 an exemplary information kiosk 102 including a help widget 120 is illustrated, according an embodiment. As shown, the help widget 120 is included on a page related to “New Accounts” but various such help widgets 120 could exist at various navigation points, and could even be present on every page. It is to be appreciated that the help widget 120 exists on a portion of the touch screen 105 that is configured to associate touch on that particular portion of the screen with an assistance request. In operation, once the information kiosk 102 senses touch on the help widget 120, a kiosk identifier and topic identifier are sent to the server 110 (via the DA Pass Through 101). The server 110 thereupon bundles this information along with a time stamp, and places an assistance request into the alert queue 112. The alert queue 112 can be organized as a FIFO queue or a priority queue, for example. Additionally, although it is disclosed that both assistance requests and strategic requests are placed in a single queue, it is to be understood that separate queues could be used. Although the illustrated help widget 120 comprises a portion of the screen 105 that is programmed to be associated with an assistance request, it is to be understood that alternatively, or in addition, another type of help widget could be used. For example, the help widget could be a physical button on the information kiosk 102 or the information kiosk 102 could be programmed such that a predetermined swiping motion could be interpreted as an assistance request. Furthermore, such “touch” could be done with a pen or special stylus instead of a human finger. Still further, the assistance request could comprise a gesture or an audio cue.

As mentioned, in another embodiment, the system 100 can generate strategic alerts without an express request for assistance from the user of the information kiosk. It is to be understood that this embodiment is substantially similar to the embodiments regarding explicit customer requests except that a strategic alert is generated when a user lands on particular navigation point(s) without the user explicitly requesting assistance. As an example, when a user lands on a section of content that is labeled “Opening New Bank Account,” the server can generate a strategic alert for “New Accounts” which can be placed in the customer alert queue. In this case, a new accounts specialist, for example, might accept the alert. The new accounts specialist, armed with information as to the user's interest in opening a low-cost new account, would be expected to contact the user in person and ask whether the user was aware, for example, that the bank was waiving account opening fees for new checking accounts this month. Such strategic alerts are a useful tool to understand what a particular client (or prospect) is looking for and would help spur a face-to-face engagement to discuss the branch's offerings.

In operation, the alert queue 112 may contain any number of strategic requests and assistance requests. In an embodiment, browser-enabled computing device users are provided the opportunity to review assistance requests in the customer alert queue 112, and either accept or reject the assistance requests. If the browser-enabled computing device user accepts the assistance request, the request would be removed from the customer alert queue and there would be an expectation that assistance would be rendered. Additionally, the browser-enabled computing device 106 can preferably be configured to capture (and send to the server 110) information regarding interactions with the customer and the disposition of the matter, including whether a “sale” was made. Collection of such information could further be used in a variety of ways, such as being used to generate various reports or input into the analytics server 180. In this case, the server 110 can provide the analytics server 180 with the pertinent information. In an embodiment, the customer alert queue is organized such that the browser-enabled computing devices 106 select only those assistance requests or strategic requests that match according to subject matter expertise of the browser-enabled computing device user. For example, a browser-enabled computing device 106 logged in by a loan officer might receive requests filtered for customer interest information pertaining to mortgages or car loans only. In some embodiments, the selection criteria would set forth logic such that available employees having matched subject matter expertise would be selected before other available employees. In this case, the user would still be provided assistance (and possibly referred for follow-up assistance, if need be) even if a subject matter expert was not presently available. In an embodiment, each assistance/strategic request in the customer alert queue is time-stamped, and the assistance requests in the queue are arranged in chronological order, so that user requests can be acted upon in order. In other cases, the customer alert queue could be organized as a priority queue where certain topics or customers are given priority.

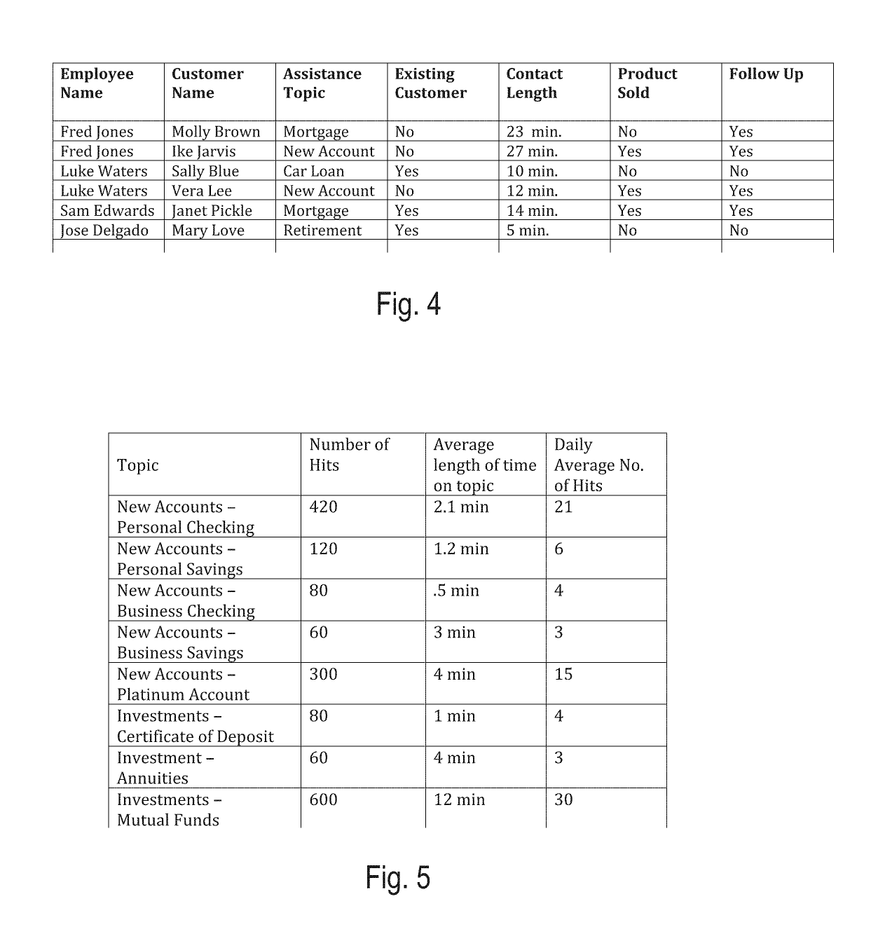

FIG. 4 and FIG. 5 illustrate exemplary reports tracking usage of an information kiosk, according to an embodiment. As shown in FIG. 4 a report showing employee engagement with customers is provided. The exemplary report includes the employee name, customer name, assistance topic, indication whether the customer is an existing customer, contact length, whether product was sold and a follow-up was done. As shown in FIG. 5, a report showing number of topic visits (“hits”), average length of time a customer spends on the topic, and the daily number of topic hits is provided. Of course, these reports are merely presented for illustrative purposes and are meant to be non-limiting examples. Furthermore, much of the information related to customer engagement can be provided to the analytics server 180 and/or cloud-based analytics system 190 for further action.

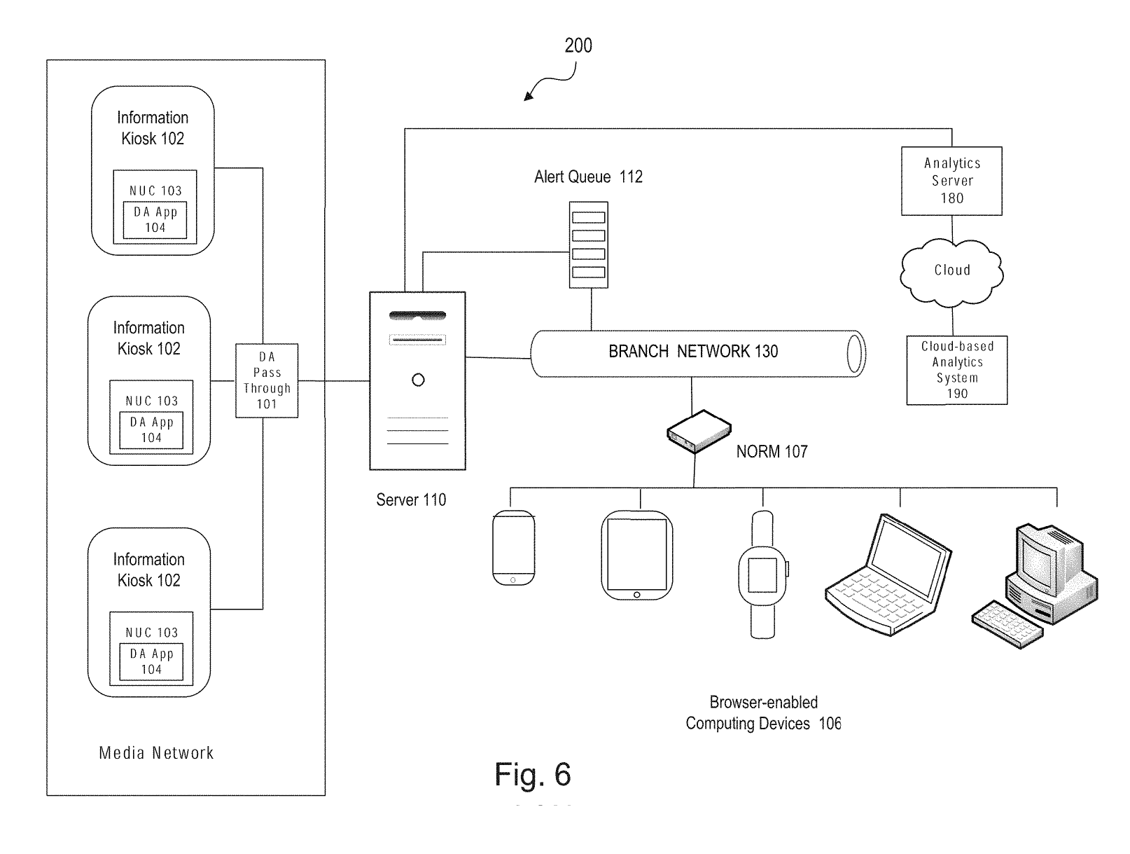

Referring to FIG. 6 a system for monitoring usage of an information kiosk 200 is illustrated, according to another embodiment. The system for monitoring usage of an information kiosk 200 is similar to the system for monitoring usage of an information kiosk 100, the difference being that one or more of the browser-enabled computing devices 106 can be connected to a network outage and redundancy module (NORM) 106, which preferably is a “headless” device connected to the branch network 130. The NORM 107 includes a microcontroller such as a programmable logic controller (PLC) or application-specific integrated circuit (ASIC) having software embedded thereon or a microprocessor having software installed in a memory device coupled thereto, to increase security, availability, and/or connectivity.

Notably, the NORM 107 can drive, monitor, and store substantially all banking activity for each of the browser-enabled computing devices 106, and the browser-enabled computing devices can include teller software and equipment, such as cash handling, check scanning and pin pads. In this embodiment, the NORM 107 can act as a universal driver operating with a variety of different browser-enabled computing devices 106. In various embodiments, the NORM 107 may be configured to receive proprietary communication of the financial services resources 106 then convert the communications to a second communication that an enterprise system or enabled computing system is able to receive. In various examples the second communication may be a universal communication protocol. In the present embodiment, the NORM 107 can also provide redundancy by continually buffering all data passing through such that for a given time period any information can be recovered. In one example, the NORM 107 may only save information from the financial services resources 106 in response to the network status being non-operational. The NORM 107 may continually monitor the branch network 130 for adequate connectivity such that in the event of any disruption the NORM 107 may activate data storage functionality. The NORM 107 may also continually monitor the branch network 130 during an outage, such that communication can begin again as soon as the network is restored. Once the network connection is restored, the NORM 107 may forward the stored communications to a computing system on the branch network 130 to return the financial services resource 106 to normal operation while maintaining the integrity of all data. An exemplary device useable for the NORM 107 is disclosed in co-pending U.S. patent application Ser. No. 13/335,645 to Chen et al., entitled “Network Outage Redundancy Module”, filed on Dec. 22, 2011, which is incorporated by reference herein in its entirety.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for monitoring an informational kiosk, comprising:
at least one information kiosk;
a server connected to the at least one information kiosk;
a local network; and
a plurality of browser-enabled computing devices connected to the server via the local network;
wherein, the server is configured to alert one or more of the browser-enabled computing devices regarding a user of the information kiosk, and the one or more alerted browser-enabled computing devices are each configured to accept the alert.

2. The system of claim 1, wherein the information kiosk is navigable by touch using a touch screen.

3. The system of claim 2, wherein the information kiosk provides products and/or services information during navigation.

4. The system of claim 2, wherein the touch screen includes at least one help widget.

5. The system of claim 4, wherein the alerted browser-enabled computing devices are alerted by
the server responsive to the user activating the help widget.

6. The system of claim 1, wherein the server alerts the alerted browser-enabled computing devices by placing alert information into a customer alert queue,
allowing one of the alerted browser-enabled computing devices to accept to the alert.

7. The system of claim 6, wherein after an alerted browser-enabled computing device accepts the
alert, the alert information is removed from the customer alert queue.

8. The system of claim 1, wherein the server captures information as to user's current navigation position at the information kiosk, and
provides such information along with the alert to the customer alert queue.

9. The system of claim 6, wherein the alerted browser-enabled computing device accepting the alert provides information regarding interactions with the user.

10. The system of claim 1, wherein the information kiosk is placed within a bank branch, the local network is a branch network, and the browser-enabled computing devices include banking personnel browser-enabled computing devices.

11. The system of claim 1, wherein the alert is provided to the one or more alerted browser-enabled computing devices in real time.

12. The system of claim 1, wherein the server captures user information and navigation history.

13. The system of claim 1, wherein only certain of the browser-enabled computing devices is selected for the alert, based at least in part on the navigation of the user and available personnel expertise.

14. The system of claim 1, wherein after the alert, the server receives from the browser-enabled computing device customer interaction information.
